(19) United States
(12) Patent Application Publication
(10) Pub. No.: US 2015/0103147 A1
(43) Pub. Date: Apr. 16, 2015

(54) IMAGE CALIBRATION SYSTEM AND CALIBRATION METHOD OF A STEREO CAMERA

(71) Applicant: Etron Technology, Inc., Hsinchu (TW)

(72) Inventors: Ming-Che Ho, Kaohsiung City (TW); Wen-Kuo Lin, Taipei City (TW)

(21) Appl. No.: 14/513,235

(22) Filed: Oct. 14, 2014

Related U.S. Application Data
(60) Provisional application No. 61/890,342, filed on Oct. 14, 2013.

(51) Int. Cl. H04N 13/02

(52) U.S. Cl. CPC H04N 13/0246; H04N 13/0239
USPC 348/47

(57) ABSTRACT

A calibration method of a stereo camera includes controlling a left eye image capture unit and a right eye image capture unit of the stereo camera to execute an image capture operation on a calibration pattern with a plurality of feature points to generate a left eye image and a right eye image, respectively; extracting a plurality of first feature points and a plurality of second feature points corresponding to the plurality of feature points from the left eye image and the right eye image, respectively; calculating camera calibration parameters corresponding to extrinsic parameters of the stereo camera according to the plurality of first feature points, the plurality of second feature points, and intrinsic parameters of the stereo camera; and executing an camera calibration process on the left eye image capture unit and the right eye image capture unit according to the camera calibration parameters, respectively.

### CROSS REFERENCE TO RELATED APPLICATIONS

This application claims the benefit of U.S. Provisional Application No. 61/890,342, filed on Oct. 14, 2013 and entitled “Stereo Camera Calibration,” the contents of which are incorporated herein by reference.

### BACKGROUND OF THE INVENTION

1. Field of the Invention

The present invention relates to an image calibration system and a calibration method of a stereo camera, and particularly to an image calibration system and a calibration method of a stereo camera that can utilize a calibration pattern with a plurality of feature points provided by a manufacturer of the stereo camera and intrinsic parameters of the stereo camera to compensate shift of extrinsic parameters of the stereo camera.

2. Description of the Prior Art

To make a stereo camera generate good quality three-dimensional images, the stereo camera usually needs higher mechanism and optical accuracy, wherein before the stereo camera is shipped, a manufacturer of the stereo camera can maintain the above mentioned higher mechanism and optical accuracy required by the stereo camera during a manufacturing process of the stereo camera. However, after the stereo camera is shipped, the above mentioned higher mechanism and optical accuracy required by the stereo camera may not be maintained due to a usage environment or a usage way of the stereo camera (e.g. the usage environment or the usage way of the stereo camera can change positions or capture image angles of left/right eye image capture units of the stereo camera, or make lenses of the left/right eye image capture units have distortion). Therefore, after the stereo camera is shipped and a user operates the stereo camera for a period of time, the stereo camera needs to be executed an camera calibration process to compensate shift of the mechanism and optical accuracy of the stereo camera.

Calibration methods provided by the prior art mainly utilize a checkerboard test pattern, and so on to repeatedly execute the camera calibration process on the stereo camera. However, most of the calibration methods provided by the prior art can be properly executed by professional trained technicians and automatic equipments during the manufacturing process of the stereo camera. Therefore, when the stereo camera needs to be executed the camera calibration process after the user operates the stereo camera for a period time, the user may need to return the stereo camera to the manufacturer of the stereo camera. Thus, the prior art is inconvenient and time-consuming, and needs addition cost for the user.

### SUMMARY OF THE INVENTION

An embodiment provides a calibration method of a stereo camera, wherein the stereo camera includes a left eye image capture unit and a right eye image capture unit. The calibration method includes controlling the left eye image capture unit and the right eye image capture unit to execute an image capture operation on a calibration pattern with a plurality of feature points to generate at least one left eye image and at least one right eye image, respectively; extracting a plurality of first feature points and a plurality of second feature points corresponding to the plurality of feature points to a memory from the at least one left eye image and the at least one right eye image, respectively; loading intrinsic parameters of the stereo camera to the memory; calculating camera calibration parameters corresponding to extrinsic parameters of the stereo camera according to the plurality of first feature points, the plurality of second feature points, and the intrinsic parameters; and executing an camera calibration process on the left eye image capture unit and the right eye image capture unit according to the camera calibration parameters, respectively.

Another embodiment provides a calibration method of a stereo camera, wherein the stereo camera includes a left eye image capture unit, a right eye image capture unit, and a memory. The calibration method includes controlling the left eye image capture unit and the right eye image capture unit to execute an image capture operation on a calibration pattern with a plurality of feature points to generate at least one left eye image and at least one right eye image, respectively; extracting a plurality of first feature points and a plurality of second feature points corresponding to the plurality of feature points to the memory from the at least one left eye image and the at least one right eye image, respectively; calculating camera calibration parameters corresponding to extrinsic parameters of the stereo camera according to the plurality of first feature points, the plurality of second feature points, and intrinsic parameters of the stereo camera stored in the memory; and executing an camera calibration process on the left eye image capture unit and the right eye image capture unit according to the camera calibration parameters, respectively.

Another embodiment provides a calibration method of a stereo camera, wherein the stereo camera includes a left eye image capture unit and a right eye image capture unit. The calibration method includes utilizing a numerical optimization method and extrinsic parameters and intrinsic parameters of the stereo camera to execute an automatic calibration operation on the left eye image capture unit and the right eye image capture unit; calculating camera calibration parameters corresponding to the extrinsic parameters of the stereo camera; executing an camera calibration process on the left eye image capture unit and the right eye image capture unit according to the camera calibration parameters corresponding to the extrinsic parameters of the stereo camera, respectively; and utilizing a cost function cost function to determine whether calibration of the left eye image capture unit and the right eye image capture unit meets a predetermined standard according to a difference between a calibrated left eye image and a calibrated right eye image generated by the left eye image capture unit and the right eye image capture unit executing an image capture operation on a calibration pattern, respectively.

Another embodiment provides an image calibration system. The image calibration system includes a stereo camera and a calibration pattern. The stereo camera includes a left eye image capture unit, a right eye image capture unit, a memory, and a processor. The calibration pattern has a plurality of feature points. The processor controls the left eye image capture unit and the right eye image capture unit to execute an image capture operation on the calibration pattern to generate at least one left eye image and at least one right eye image respectively, extracts a plurality of first feature points and a plurality of second feature points corresponding to the plurality of feature points to the memory from the at least one left eye image and the at least one right eye image respectively, calculates camera calibration parameters corresponding to extrinsic parameters of the stereo camera according to the plurality of first feature points, the plurality of second feature points, and intrinsic parameters of the stereo camera, and executes an camera calibration process on the left eye image capture unit and the right eye image capture unit according to the camera calibration parameters, respectively.

Another embodiment provides an image calibration system. The image calibration system includes a stereo camera and a calibration pattern. The stereo camera includes a left eye image capture unit and a right eye image capture unit. The calibration pattern has a plurality of feature points. The stereo camera is electrically connected to a device outside the stereo camera to execute an camera calibration process, wherein a processor of the device controls the left eye image capture unit and the right eye image capture unit to execute an image capture operation on the calibration pattern to generate at least one left eye image and at least one right eye image respectively, extracts a plurality of first feature points and a plurality of second feature points corresponding to the plurality of feature points to a memory of the device from the at least one left eye image and the at least one right eye image respectively, loads intrinsic parameters of the stereo camera to the memory, calculates camera calibration parameters corresponding to extrinsic parameters of the stereo camera according to the plurality of first feature points and the plurality of second feature points, and the intrinsic parameters, and executes the camera calibration process on the left eye image capture unit and the right eye image capture unit according to the camera calibration parameters, respectively.

Another embodiment provides an image calibration system. The image calibration system includes a stereo camera and a calibration pattern. The stereo camera includes a left eye image capture unit, a right eye image capture unit, and a processor. The processor utilizes a numerical optimization method and intrinsic parameters and extrinsic parameters of the stereo camera to execute an automatic calibration operation on the left eye image capture unit and the right eye image capture unit, calculates camera calibration parameters corresponding to the extrinsic parameters of the stereo camera after the processor executes the automatic calibration operation, executes an camera calibration process on the left eye image capture unit and the right eye image capture unit according to the camera calibration parameters corresponding to the extrinsic parameters of the stereo camera respectively, and utilizes a cost function to determine whether calibration of the left eye image capture unit and the right eye image capture unit meets a predetermined standard according to a difference between a calibrated left eye image and a calibrated right eye image generated by the left eye image capture unit and the right eye image capture unit executing an image capture operation on the calibration pattern respectively after the processor executes the camera calibration process.

Another embodiment provides an image calibration system. The image calibration system includes a stereo camera and a calibration pattern. The stereo camera includes a left eye image capture unit and a right eye image capture unit. The stereo camera is electrically connected to a device outside the stereo camera to execute an camera calibration process, wherein a processor of the device loads intrinsic parameters and extrinsic parameters of the stereo camera, utilizes a numerical optimization method and the intrinsic parameters and the extrinsic parameters of the stereo camera to execute an automatic calibration operation on the left eye image capture unit and the right eye image capture unit, calculates camera calibration parameters corresponding to the extrinsic parameters of the stereo camera after the processor executes the automatic calibration operation, executes the camera calibration process on the left eye image capture unit and the right eye image capture unit according to the camera calibration parameters corresponding to the extrinsic parameters of the stereo camera respectively, and utilizes a cost function to determine whether calibration of the left eye image capture unit and the right eye image capture unit meets a predetermined standard according to a difference between a calibrated left eye image and a calibrated right eye image generated by the left eye image capture unit and the right eye image capture unit executing an image capture operation on the calibration pattern respectively after the processor executes the camera calibration process.

Another embodiment provides an image calibration system. The image calibration system includes a stereo camera, wherein the stereo camera includes a left eye image capture unit, a right eye image capture unit, and a processor, wherein the processor is electrically connected to the left eye image capture unit and the right eye image capture unit, and the stereo camera has intrinsic parameters. The processor controls the left eye image capture unit and the right eye image capture unit to execute an image capture operation on a calibration pattern with a plurality of feature points to generate a plurality of first feature points and a plurality of second feature points corresponding to the plurality of feature points, calculates camera calibration parameters corresponding to the stereo camera according to the plurality of first feature points, the plurality of second feature points, and the intrinsic parameters, and executes an camera calibration process on the left eye image capture unit and the right eye image capture unit according to the camera calibration parameters.

The present invention provides an image calibration system and a calibration method of a stereo camera. Because extrinsic parameters (or intrinsic parameters and the extrinsic parameters) of the stereo camera may shift due to a usage environment, a usage way, or a usage condition of the stereo camera after the stereo camera is shipped and operated for a period of time by a user, resulting in mechanism and optical accuracy of the stereo camera being reduced, the image calibration system and the calibration method provided by the present invention are suitable for the stereo camera which is shipped and operated for a period of time by the user. Because the present invention utilizes a calibration pattern with a plurality of feature points (printed in a board or displayed on a display) provided by a manufacturer of the stereo camera and the intrinsic parameters of the stereo camera to compensate shift of the extrinsic parameters of the stereo camera, and the present invention can also utilize a numerical optimization method provided by the prior art and the intrinsic parameters and the extrinsic parameters of the stereo camera to execute an automatic calibration operation on a left eye image capture unit and a right eye image capture unit of the stereo camera, compared to the prior art, the present invention is more convenient and inexpensive for the user and the user does not need a professional skill to execute the present invention.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a stereo camera, a device, and a calibration pattern.

FIG. 2 is a flowchart illustrating a calibration method of a stereo camera according to a first embodiment.

FIG. 3 is a diagram illustrating a left eye image.

FIG. 4 is a diagram illustrating a right eye image.

FIG. 6 is a flowchart illustrating a calibration method of a stereo camera according to a second embodiment.

FIG. 7 is a flowchart illustrating a calibration method of a stereo camera according to a third embodiment.

FIG. 8 is a flowchart illustrating a calibration method of a stereo camera according to a fourth embodiment.

### DETAILED DESCRIPTION

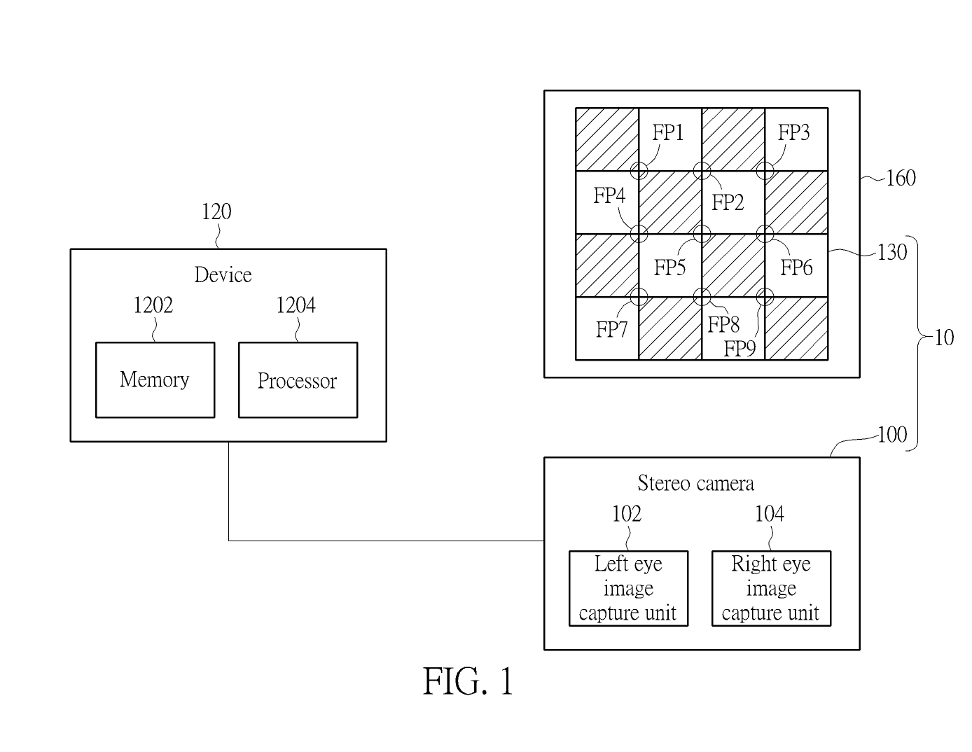

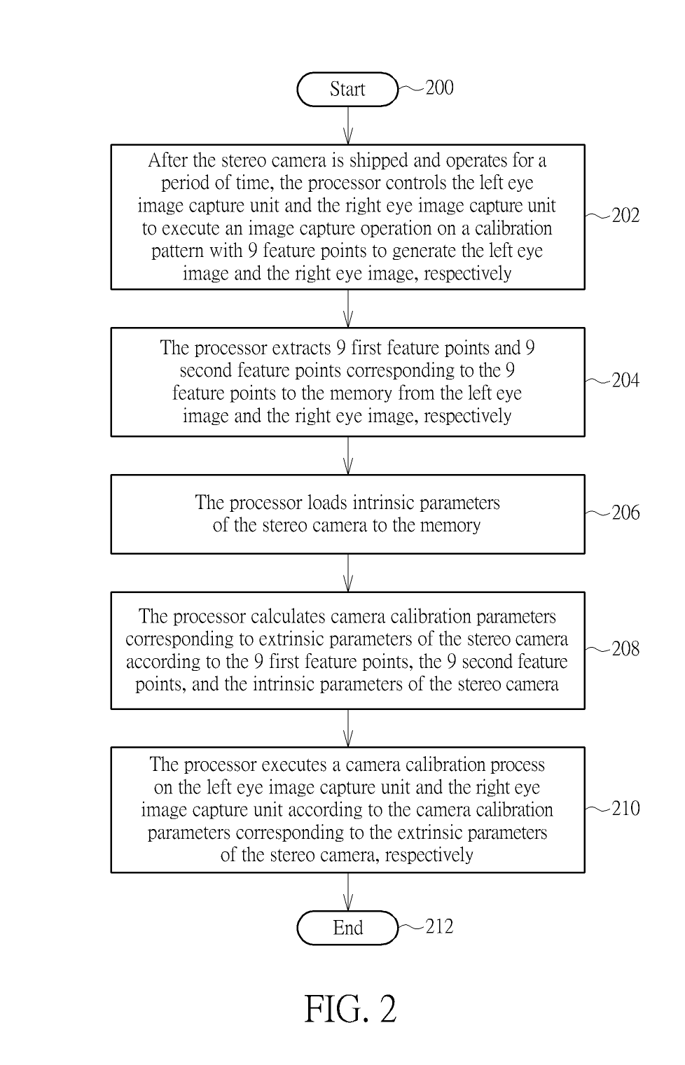

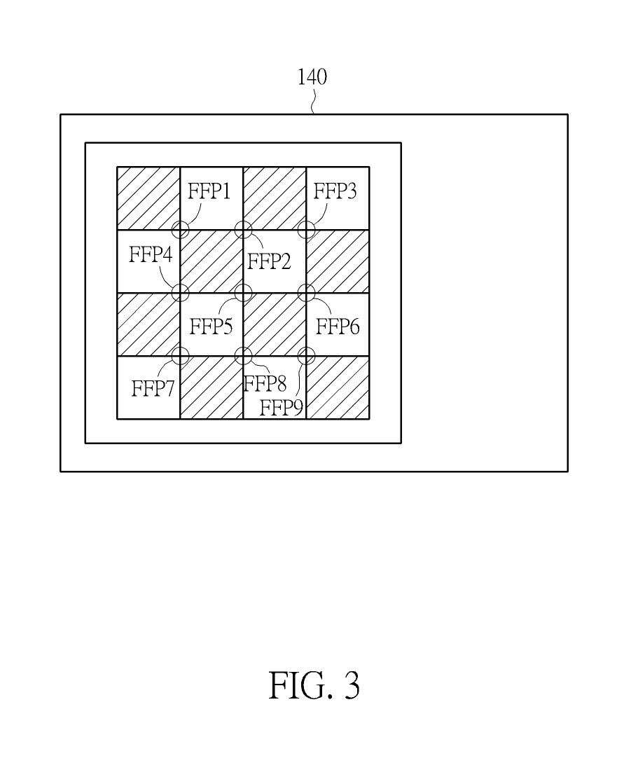

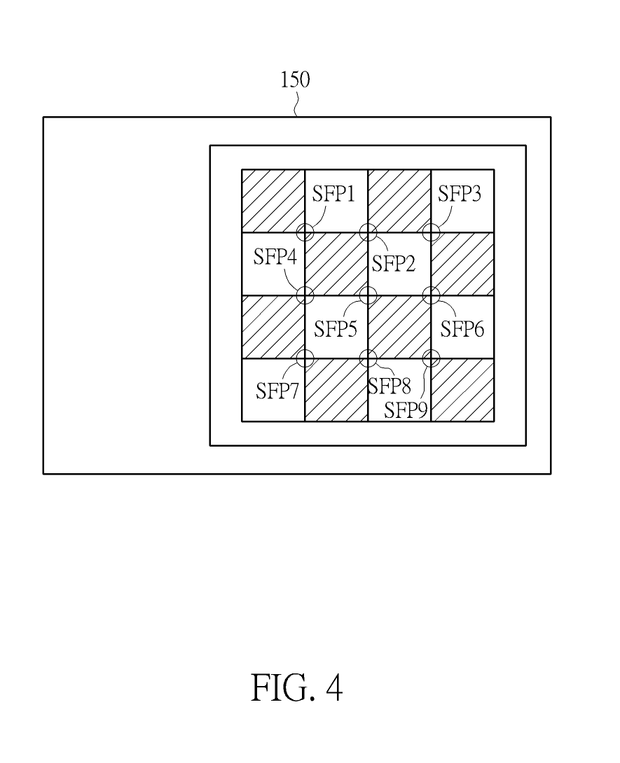

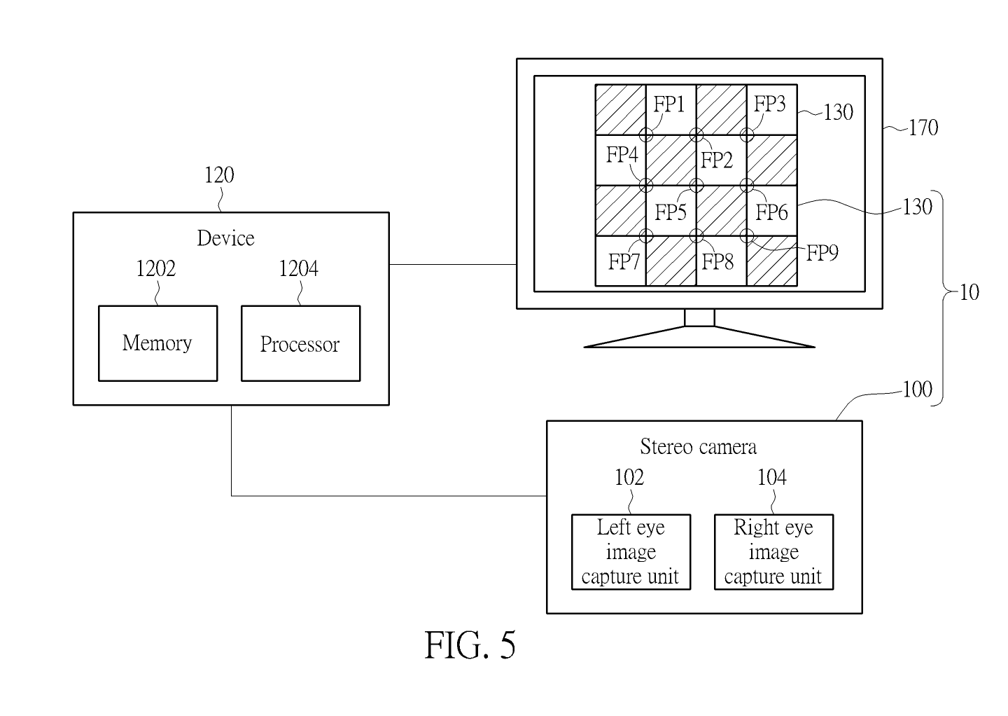

Please refer to FIG. 1. FIG. 1 is a diagram illustrating a stereo camera 100, a device 120, and a calibration pattern 130, wherein the stereo camera 100 and the calibration pattern 130 are included in an image calibration system 10, the stereo camera 100 includes a left eye image capture unit 102 and a right eye image capture unit 104, and the device 120 includes a memory 1202 and a processor 1204. Please refer to FIGS. 2-4. FIG. 2 is a flowchart illustrating a calibration method of a stereo camera according to a first embodiment, FIG. 3 is a diagram illustrating a left eye image 140, and FIG. 4 is a diagram illustrating a right eye image 150. The calibration method in FIG. 2 is illustrated using the image calibration system 10 and the device 120 in FIG. 1. Detailed steps are as follows:

Step 200: Start.

Step 202: After the stereo camera 100 is shipped and operates for a period of time, the processor 1204 controls the left eye image capture unit 102 and the right eye image capture unit 104 to execute an image capture operation on a calibration pattern 130 with 9 feature points FP1-FP9 to generate the left eye image 140 and the right eye image 150, respectively.

Step 204: The processor 1204 extracts 9 first feature points FFP1-FFP9 and 9 second feature points SFP1-SFP9 corresponding to the 9 feature points FP1-FP9 to the memory 1202 from the left eye image 140 and the right eye image 150, respectively.

Step 206: The processor 1204 loads intrinsic parameters of the stereo camera 100 to the memory 1202.

Step 208: The processor 1204 calculates camera calibration parameters corresponding to extrinsic parameters of the stereo camera 100 according to the 9 first feature points FFP1-FFP9, the 9 second feature points SFP1-SFP9, and the intrinsic parameters of the stereo camera 100.

Step 210: The processor 1204 executes a camera calibration process on the left eye image capture unit 102 and the right eye image capture unit 104 according to the camera calibration parameters corresponding to the extrinsic parameters of the stereo camera 100, respectively.

Step 212: End.

After the stereo camera 100 is shipped and operates for a period of time, the extrinsic parameters of the stereo camera 100 may shift due to a usage environment, a usage way, or a usage condition of the stereo camera 100, resulting in mechanism and optical accuracy of the stereo camera 100 being reduced, wherein the extrinsic parameters of the stereo camera 100 include a position of the left eye image capture unit 102, a position of the right eye image capture unit 104, a distance between the left eye image capture unit 102 and the right eye image capture unit 104, a relative rotation angle between the left eye image capture unit 102 and the right eye image capture unit 104, and a relative skew between the left eye image capture unit 102 and the right eye image capture unit 104. Therefore, the stereo camera 100 needs to be executed the camera calibration process to compensate shift of the extrinsic parameters of the stereo camera 100. In Step 202, after the device 120 is electrically connected to the stereo camera 100, the processor 1204 can control the left eye image capture unit 102 and the right eye image capture unit 104 to execute the image capture operation on the calibration pattern 130 with the 9 feature points FP1-FP9 to generate the left eye image 140 and the right eye image 150, respectively, wherein the calibration pattern 130 is printed on a flat board 160 (as shown in FIG. 1). But, the present invention is not limited to a shape and a pattern of the calibration pattern 130 shown in FIG. 1. But, in another embodiment of the present invention, the calibration pattern 130 is stored in a storage device and can be displayed on a display 170 (as shown in FIG. 5). In addition, the present invention is not limited to the calibration pattern 130 having the 9 feature points FP1-FP9, that is, the calibration pattern 130 can have a plurality of feature points. As shown in FIGS. 3, 4, because the calibration pattern 130 has the 9 feature points FP1-FP9, the left eye image 140 generated by the left eye image capture unit 102 also has the 9 first feature points FFP1-FFP9 and the right eye image 150 generated by the right eye image capture unit 104 also has the 9 second feature points SFP1-SFP9. As shown in FIGS. 3-4, in Step 204, because the left eye image 140 has the 9 first feature points FFP1-FFP9 and the right eye image 150 has the 9 second feature points SFP1-SFP9, the processor 1204 can extract the 9 first feature points FFP1-FFP9 and the 9 second feature points SFP1-SFP9 corresponding to the 9 feature points FP1-FP9 to the memory 1202 from the left eye image 140 and the right eye image 150, respectively. In Step 206, the processor 1204 loads the intrinsic parameters of the stereo camera 100 to the memory 1202, wherein the intrinsic parameters of the stereo camera 100 include a lens focal length, an optical axis, a lens distortion, and so on corresponding to the left eye image capture unit 102, and a lens focal length, an optical axis, a lens distortion, and so on corresponding to the right eye image capture unit 104. In addition, the intrinsic parameters of the stereo camera 100 are stored in a server of a manufacturer of the stereo camera 100, or stored in a storage device provided by the manufacturer of the stereo camera 100. In Step 208, After the processor 1204 loads the intrinsic parameters of the stereo camera 100 to the memory 1202, the processor 1204 can calculate the camera calibration parameters corresponding to the extrinsic parameters of the stereo camera 100 according to the 9 first feature points FFP1-FFP9 extracted from the left eye image 140, the 9 second feature points SFP1-SFP9 extracted from the right eye image 150, and the intrinsic parameters of the stereo camera 100. In Step 210, after the processor 1204 calculates the camera calibration parameters corresponding to the extrinsic parameters of the stereo camera 100, the processor 1204 can execute the camera calibration process on the left eye image capture unit 102 and the right eye image capture unit 104 according to the camera calibration parameters corresponding to the extrinsic parameters of the stereo camera 100, respectively. That is to say, because the usage environment, the usage way, or the usage condition of the stereo camera 100 causes shift of the extrinsic parameters of the stereo camera 100, the processor 1204 can compensate (rectify) left eye images generated by the left eye image capture unit 102 and right eye images generated by the right eye image capture unit 104 according to the camera calibration parameters corresponding to the extrinsic parameters of the stereo camera 100, respectively. In addition, in one embodiment of the present invention, a purpose of the camera calibration process makes a plurality of first feature points of a left eye image generated by the left eye image capture unit 102 align a plurality of second feature points of a right eye image generated by the right eye image capture unit 104 (e.g. row alignment between the left image and the right image) to save memory space needed by following process of the processor 1204, wherein the row alignment means that on an image plane, each of the plurality of first feature points of the left eye image and a corresponding feature point of the plurality of second feature points of the right eye image are located on the same Y axis (when the left eye image capture unit 102 and the right eye image capture unit 104 are placed on the horizontal placement). In another embodiment aligning a plurality of second feature points of a right eye image generated by the right eye image capture unit 104 could be column alignment when the left eye image capture unit 102 and the right eye image capture unit 104 are placed on vertical placement. In addition, in another embodiment of the present invention, the device 120 is included in the stereo camera 100, wherein when the stereo camera 100 includes the device 120, the intrinsic parameters (and the extrinsic parameters) of the stereo camera 100 are stored in the memory 1202, or the processor 1202 loads the intrinsic parameters (and the extrinsic parameters) of the stereo camera 100 to the memory 1204 from the server of the manufacturer of the stereo camera 100 or the storage device provided by the manufacturer of the stereo camera 100. In addition, after the stereo camera 100 is shipped and operates for a period of time, the intrinsic parameters and the extrinsic parameters of the stereo camera 100 may shift due to the usage environment, the usage way, or the usage condition of the stereo camera 100, resulting in mechanism and optical accuracy of the stereo camera 100 being reduced, so in another embodiment of the present invention, in Step 208, the processor 1204 can calculate camera calibration parameters corresponding to the intrinsic parameters and the extrinsic parameters of the stereo camera 100 according to the 9 first feature points FFP1-FFP9 extracted from the left eye image 140 and the 9 second feature points SFP1-SFP9 extracted from the right eye image 150, and in Step 210, the processor 1204 can execute an camera calibration process on the left eye image capture unit 102 and the right eye image capture unit 104 according to the camera calibration parameters corresponding to the intrinsic parameters and the extrinsic parameters of the stereo camera 100, respectively. In addition, in one embodiment of the present invention, the calibration pattern 130 used in this invention is a single frame pattern, instead of being composed of a plurality of frame patterns (such as patterns on different angles or distances) used by the prior art. Therefore, compared to the prior art, the present invention is more convenient and inexpensive for a user and the user does not need a professional skill to execute the present invention. In addition, in another embodiment of the present invention, the image calibration system 10 includes the stereo camera 100.

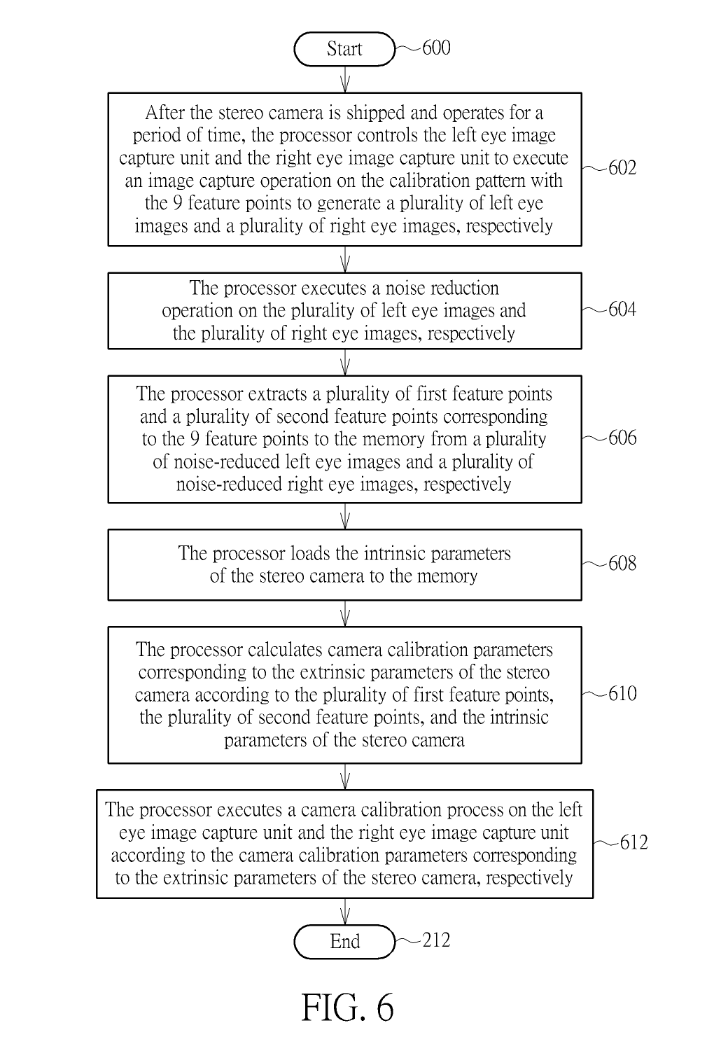

Please refer to FIGS. 1, 3, 4, 6. FIG. 6 is a flowchart illustrating a calibration method of a stereo camera according to a second embodiment. The calibration method in FIG. 6 is illustrated using the image calibration system 10 and the device 120 in FIG. 1. Detailed steps are as follows:

Step 600: Start.

Step 602: After the stereo camera 100 is shipped and operates for a period of time, the processor 1204 controls the left eye image capture unit 102 and the right eye image capture unit 104 to execute an image capture operation on the calibration pattern 130 with the 9 feature points FP1-FP9 to generate a plurality of left eye images and a plurality of right eye images, respectively.

Step 604: The processor 1204 executes a noise reduction operation on the plurality of left eye images and the plurality of right eye images, respectively.

Step 606: The processor 1204 extracts a plurality of first feature points and a plurality of second feature points corresponding to the 9 feature points FP1-FP9 to the memory 1202 from a plurality of noise-reduced left eye images and a plurality of noise-reduced right eye images, respectively.

Step 608: The processor 1204 loads the intrinsic parameters of the stereo camera 100 to the memory 1202.

Step 610: The processor 1204 calculates camera calibration parameters corresponding to the extrinsic parameters of the stereo camera 100 according to the plurality of first feature points, the plurality of second feature points, and the intrinsic parameters of the stereo camera 100.

Step 612: The processor 1204 executes a camera calibration process on the left eye image capture unit 102 and the right eye image capture unit 104 according to the camera calibration parameters corresponding to the extrinsic parameters of the stereo camera 100, respectively.

Step 614: End.

Differences between the embodiment in FIG. 6 and the embodiment in FIG. 2 are that in Step 602, the processor 1204 controls the left eye image capture unit 102 and the right eye image capture unit 104 to execute the image capture operation on the calibration pattern 130 with the 9 feature points FP1-FP9 to generate the plurality of left eye images (e.g. the plurality of left eye images similar to the left eye image 140 shown in FIG. 3) and the plurality of right eye images (e.g. the plurality of right eye images similar to the right eye image 150 shown in FIG. 4) during a predetermined period, respectively; in Step 604, the processor 1204 executes the noise reduction operation on the plurality of left eye images and the plurality of right eye images, respectively; and in Step 606, the processor 1204 extracts the plurality of first feature points and the plurality of second feature points corresponding to the 9 feature points FP1-FP9 to the memory 1202 from the plurality of noise-reduced left eye images and the plurality of noise-reduced right eye images, respectively. In addition, subsequent operational principles of the embodiment in FIG. 6 are the same as those of the embodiment in FIG. 2, so further description thereof is omitted for simplicity.

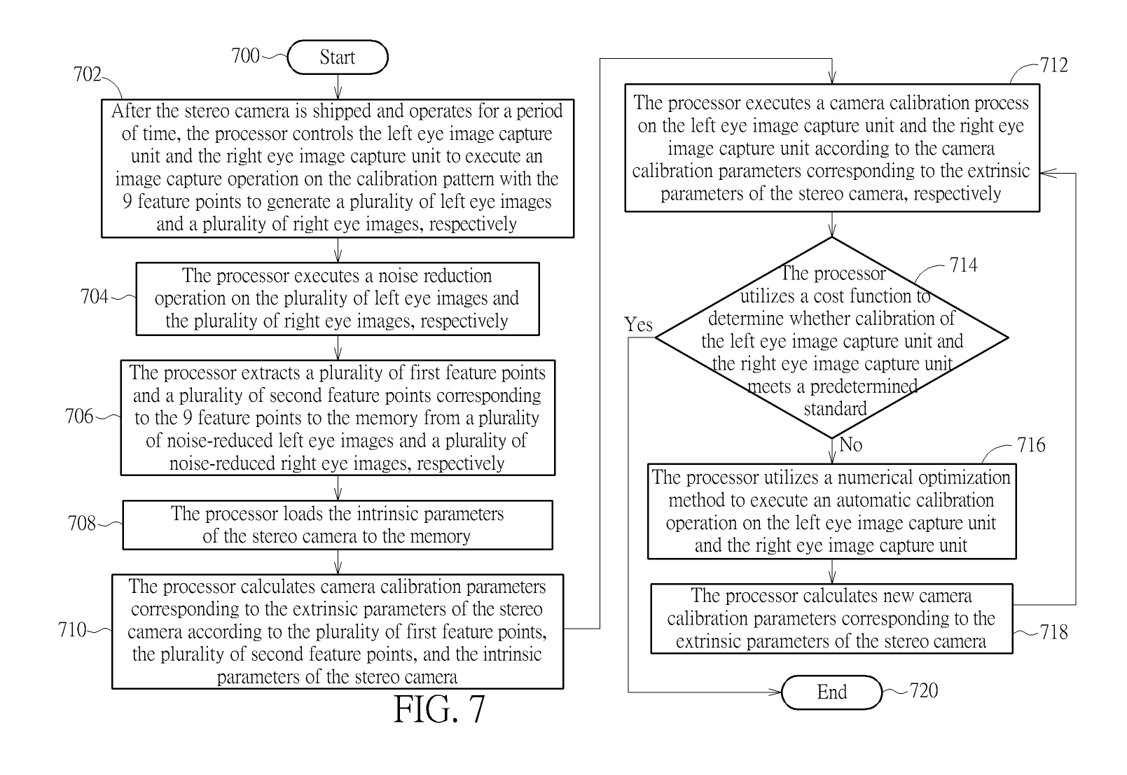

Please refer to FIGS. 1, 7. FIG. 7 is a flowchart illustrating a calibration method of a stereo camera according to a third embodiment. The calibration method in FIG. 7 is illustrated using the image calibration system 10 and the device 120 in FIG. 1. Detailed steps are as follows:

Step 700: Start.

Step 702: After the stereo camera 100 is shipped and operates for a period of time, the processor 1204 controls the left eye image capture unit 102 and the right eye image capture unit 104 to execute an image capture operation on the calibration pattern 130 with the 9 feature points FP1-FP9 to generate a plurality of left eye images and a plurality of right eye images, respectively.

Step 704: The processor 1204 executes a noise reduction operation on the plurality of left eye images and the plurality of right eye images, respectively.

Step 706: The processor 1204 extracts a plurality of first feature points and a plurality of second feature points corresponding to the 9 feature points FP1-FP9 to the memory 1202 from a plurality of noise-reduced left eye images and a plurality of noise-reduced right eye images, respectively.

Step 708: The processor 1204 loads the intrinsic parameters of the stereo camera 100 to the memory 1202.

Step 710: The processor 1204 calculates camera calibration parameters corresponding to the extrinsic parameters of the stereo camera 100 according to the plurality of first feature points, the plurality of second feature points, and the intrinsic parameters of the stereo camera 100.

Step 712: The processor 1204 executes a camera calibration process on the left eye image capture unit 102 and the right eye image capture unit 104 according to the camera calibration parameters corresponding to the extrinsic parameters of the stereo camera 100, respectively.

Step 714: The processor 1204 utilizes a cost function to determine whether calibration of the left eye image capture unit 102 and the right eye image capture unit 104 meets a predetermined standard; if yes, go to Step 720; if no, go to Step 716.

Step 716: The processor 1204 utilizes a numerical optimization method to execute an automatic calibration operation on the left eye image capture unit 102 and the right eye image capture unit 104.

Step 718: The processor 1204 calculates new camera calibration parameters corresponding to the extrinsic parameters of the stereo camera 100, go to Step 712.

Step 720: End.

Differences between the embodiment in FIG. 7 and the embodiment in FIG. 6 are that in Step 714, the processor 1204 utilizes the cost function ∘ determine whether the calibration of the left eye image capture unit 102 and the right eye image capture unit 104 meets the predetermined standard according to a difference between a calibrated left eye image and a calibrated right eye image generated by the left eye image capture unit 102 and the right eye image capture unit 104 executing the image capture operation on the calibration pattern 130, respectively, wherein the cost function corresponds to an absolute difference between the calibrated left eye image and the calibrated right eye image, but, the present invention is not limited to the cost function corresponding to the absolute difference between the calibrated left eye image and the calibrated right eye image; in Step 716, the processor 1204 utilizes the numerical optimization method provided by the prior art to execute the automatic calibration operation on the left eye image capture unit 102 and the right eye image capture unit 104, that is, the processor 1204 utilizes the numerical optimization method provided by the prior art to minimize the cost function; and in Step 718, after the processor 1204 executes the automatic calibration operation on the left eye image capture unit 102 and the right eye image capture unit 104, the processor 1204 can calculate the new camera calibration parameters corresponding to the extrinsic parameters of the stereo camera 100. In addition, subsequent operational principles of the embodiment in FIG. 7 are the same as those of the embodiment in FIG. 6, so further description thereof is omitted for simplicity.

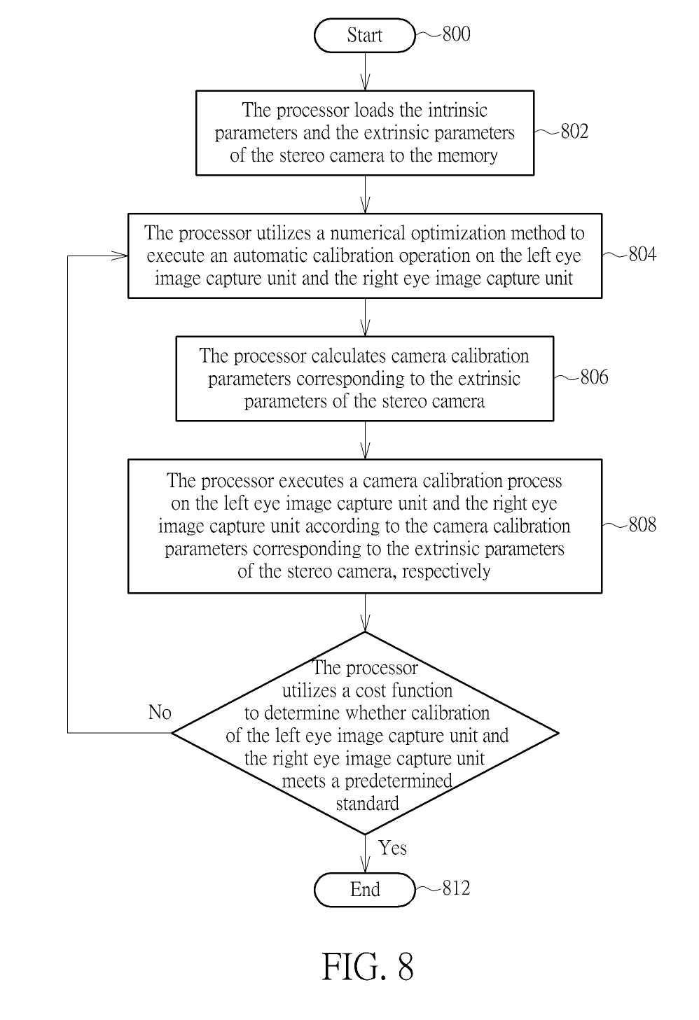

Please refer to FIGS. 1, 8. FIG. 8 is a flowchart illustrating a calibration method of a stereo camera according to a fourth embodiment. The calibration method in FIG. 8 is illustrated using the image calibration system 10 and the device 120 in FIG. 1. Detailed steps are as follows:

Step 800: Start.

Step 802: The processor 1204 loads the intrinsic parameters and the extrinsic parameters of the stereo camera 100 to the memory 1202.

Step 804: The processor 1204 utilizes a numerical optimization method to execute an automatic calibration operation on the left eye image capture unit 102 and the right eye image capture unit 104.

Step 806: The processor 1204 calculates camera calibration parameters corresponding to the extrinsic parameters of the stereo camera 100.

Step 808: The processor 1204 executes a camera calibration process on the left eye image capture unit 102 and the right eye image capture unit 104 according to the camera calibration parameters corresponding to the extrinsic parameters of the stereo camera 100, respectively

Step 810: The processor 1204 utilizes a cost function to determine whether calibration of the left eye image capture unit 102 and the right eye image capture unit 104 meets a predetermined standard; if yes, go to Step 812; if no, go to Step 804;

Step 812: End.

Differences between the embodiment in FIG. 8 and the embodiments in FIGS. 2, 6, 7 are that in Step 802, the processor 1204 loads the intrinsic parameters and the extrinsic parameters of the stereo camera 100 to the memory 1202; and in Step 804, the processor 1204 utilizes the numerical optimization method and the intrinsic parameters and the extrinsic parameters of the stereo camera 100 to execute the automatic calibration operation on the left eye image capture unit 102 and the right eye image capture unit 104. In addition, Step 806 can be referred to Step 718, Step 808 can be referred to Step 712, and Step 810 can be referred to Step 714, so subsequent operational principles of Steps 806, 808, 810 are omitted for simplicity.

To sum up, because the extrinsic parameters (or the intrinsic parameters and the extrinsic parameters) of the stereo camera may shift due to the usage environment, the usage way, or the usage condition of the stereo camera after the stereo camera is shipped and operated for a period of time by the user, resulting in mechanism and optical accuracy of the stereo camera being reduced, the image calibration system and the calibration method provided by the present invention are suitable for the stereo camera which is shipped and operated for a period of time by the user. Because the present invention utilizes a calibration pattern with a plurality of feature point (printed in the board or displayed on the display) provided by the manufacturer of the stereo camera and the intrinsic parameters of the stereo camera to compensate shift of the extrinsic parameters of the stereo camera, and the present invention can also utilize the numerical optimization method provided by the prior art and the intrinsic parameters and the extrinsic parameters of the stereo camera to execute the automatic calibration operation on the left eye image capture unit and the right eye image capture unit, compared to the prior art, the present invention is more convenient and inexpensive for the user and the user does not need a professional skill to execute the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A calibration method of a stereo camera, wherein the stereo camera comprises a left eye image capture unit and a right eye image capture unit, the calibration method comprising:
controlling the left eye image capture unit and the right eye image capture unit to execute an image capture operation on a calibration pattern with a plurality of feature points to generate at least one left eye image and at least one right eye image, respectively;
extracting a plurality of first feature points and a plurality of second feature points corresponding to the plurality of feature points to a memory from the at least one left eye image and the at least one right eye image, respectively;
loading intrinsic parameters of the stereo camera to the memory;
calculating camera calibration parameters corresponding to extrinsic parameters of the stereo camera according to the plurality of first feature points, the plurality of second feature points, and the intrinsic parameters; and
executing an camera calibration process on the left eye image capture unit and the right eye image capture unit according to the camera calibration parameters, respectively.

2. The calibration method of claim 1, further comprising:
executing a noise reduction operation on the at least one left eye image and the at least one right eye image.

3. The calibration method of claim 1, further comprising:
a processor utilizing a cost function to determine whether calibration of the left eye image capture unit and the right eye image capture unit meets a predetermined standard according to a difference between a calibrated left eye image and a calibrated right eye image generated by the left eye image capture unit and the right eye image capture unit executing the image capture operation on the calibration pattern respectively after executing the camera calibration process on the left eye image capture unit and the right eye image capture unit according to the camera calibration parameters, respectively.

4. The calibration method of claim 3, wherein when the calibration of the left eye image capture unit and the right eye image capture unit fails to meet the predetermined standard, the calibration method further comprises:
utilizing a numerical optimization method to execute an automatic calibration operation on the left eye image capture unit and the right eye image capture unit;
calculating new camera calibration parameters corresponding to the extrinsic parameters of the stereo camera; and
executing the camera calibration process on the left eye image capture unit and the right eye image capture unit according to the new camera calibration parameters, respectively.

5. The calibration method of claim 1, wherein the intrinsic parameters of the stereo camera comprise a lens focal length, an optical axis, and a lens distortion corresponding to the left eye image capture unit, and a lens focal length, an optical axis, and a lens distortion corresponding to the right eye image capture unit.

6. The calibration method of claim 1, wherein the extrinsic parameters of the stereo camera comprise a position of the left eye image capture unit, a position of the right eye pattern capture unit, a distance between the left eye image capture unit and the right eye pattern capture unit, a relative rotation angle between the left eye image capture unit and the right eye pattern capture unit, and a relative skew between the left eye image capture unit and the right eye pattern capture unit.

7. The calibration method of claim 1, wherein the calibration pattern is printed on a board or displayed on a display.

8. A calibration method of a stereo camera, wherein the stereo camera comprises a left eye image capture unit, a right eye image capture unit, and a memory, the calibration method comprising:
controlling the left eye image capture unit and the right eye image capture unit to execute an image capture operation on a calibration pattern with a plurality of feature points to generate at least one left eye image and at least one right eye image, respectively;
extracting a plurality of first feature points and a plurality of second feature points corresponding to the plurality of feature points to the memory from the at least one left eye image and the at least one right eye image, respectively;
calculating camera calibration parameters corresponding to extrinsic parameters of the stereo camera according to the plurality of first feature points, the plurality of second feature points, and intrinsic parameters of the stereo camera stored in the memory; and
executing an camera calibration process on the left eye image capture unit and the right eye image capture unit according to the camera calibration parameters, respectively.

9. The calibration method of claim 8, wherein the intrinsic parameters of the stereo camera comprise a lens focal length, an optical axis, and a lens distortion corresponding to the left eye image capture unit, and a lens focal length, an optical axis, and a lens distortion corresponding to the right eye image capture unit.

10. The calibration method of claim 8, wherein the extrinsic parameters of the stereo camera comprise a position of the left eye image capture unit, a position of the right eye pattern capture unit, a distance between the left eye image capture unit and the right eye pattern capture unit, a relative rotation angle between the left eye image capture unit and the right eye pattern capture unit, and a relative skew between the left eye image capture unit and the right eye pattern capture unit.

11. The calibration method of claim 8, wherein the calibration pattern is printed on a board or displayed on a display.

12. A calibration method of a stereo camera, wherein the stereo camera comprises a left eye image capture unit and a right eye image capture unit, the calibration method comprising:
utilizing a numerical optimization method and extrinsic parameters and intrinsic parameters of the stereo camera to execute an automatic calibration operation on the left eye image capture unit and the right eye image capture unit;
calculating camera calibration parameters corresponding to the extrinsic parameters of the stereo camera;
executing an camera calibration process on the left eye image capture unit and the right eye image capture unit according to the camera calibration parameters corresponding to the extrinsic parameters of the stereo camera, respectively; and
utilizing a cost function cost function to determine whether calibration of the left eye image capture unit and the right eye image capture unit meets a predetermined standard according to a difference between a calibrated left eye image and a calibrated right eye image generated by the left eye image capture unit and the right eye image capture unit executing an image capture operation on a calibration pattern, respectively.

13. The calibration method of claim 12, wherein when the calibration of the left eye image capture unit and the right eye image capture unit fails to meet the predetermined standard, the calibration method further comprises:
utilizing the numerical optimization method and the intrinsic parameters and the extrinsic parameters of the stereo camera to execute the automatic calibration operation on the left eye image capture unit and the right eye image capture unit again.

14. The calibration method of claim 12, further comprising:
loading the intrinsic parameters and the extrinsic parameters of the stereo camera.

15. The calibration method of claim 12, wherein the intrinsic parameters of the stereo camera comprise a lens focal length, an optical axis, and a lens distortion corresponding to the left eye image capture unit, and a lens focal length, an optical axis, and a lens distortion corresponding to the right eye image capture unit.

16. The calibration method of claim 12, wherein the extrinsic parameters of the stereo camera comprise a position of the left eye image capture unit, a position of the right eye pattern capture unit, a distance between the left eye image capture unit and the right eye pattern capture unit, a relative rotation angle between the left eye image capture unit and the right eye pattern capture unit, and a relative skew between the left eye image capture unit and the right eye pattern capture unit.

17. The calibration method of claim 12, wherein the calibration pattern is printed on a board or displayed on a display.

18. An image calibration system, comprising:
a stereo camera comprising a left eye image capture unit, a right eye image capture unit, a memory, and a processor; and
a calibration pattern having a plurality of feature points;
wherein the processor controls the left eye image capture unit and the right eye image capture unit to execute an image capture operation on the calibration pattern to generate at least one left eye image and at least one right eye image respectively, extracts a plurality of first feature points and a plurality of second feature points corresponding to the plurality of feature points to the memory from the at least one left eye image and the at least one right eye image respectively, calculates camera calibration parameters corresponding to extrinsic parameters of the stereo camera according to the plurality of first feature points, the plurality of second feature points, and intrinsic parameters of the stereo camera, and executes an camera calibration process on the left eye image capture unit and the right eye image capture unit according to the camera calibration parameters, respectively.

19. The image calibration system of claim 18, wherein the processor further executes a noise reduction operation on the at least one left eye image and the at least one right eye image.

20. The image calibration system of claim 18, wherein the processor further utilizes a cost function to determine whether calibration of the left eye image capture unit and the right eye image capture unit meets a predetermined standard according to a difference between a calibrated left eye image and a calibrated right eye image generated by the left eye image capture unit and the right eye image capture unit executing the image capture operation on the calibration pattern respectively after the processor executes the camera calibration process on the left eye image capture unit and the right eye image capture unit according to the camera calibration parameters, respectively.

21. The image calibration system of claim 20, wherein when the calibration of the left eye image capture unit and the right eye image capture unit fails to meet the predetermined standard, the processor further utilizes a numerical optimization method to execute an automatic calibration operation on the left eye image capture unit and the right eye image capture unit, calculates new camera calibration parameters corresponding to the extrinsic parameters of the stereo camera after the processor utilizes the numerical optimization method to execute the automatic calibration operation on the left eye image capture unit and the right eye image capture unit, and executes the camera calibration process on the left eye image capture unit and the right eye image capture unit according to the new camera calibration parameters, respectively.

22. The image calibration system of claim 18, wherein the intrinsic parameters of the stereo camera is stored in the memory.

23. The image calibration system of claim 18, wherein the processor further loads the intrinsic parameters of the stereo camera to the memory.

24. The image calibration system of claim 18, wherein the calibration pattern is printed on a board, or the calibration pattern is stored in a storage device for being displayed on a display.

25. An image calibration system, comprising:
a stereo camera comprising a left eye image capture unit and a right eye image capture unit; and
a calibration pattern having a plurality of feature points;
wherein the stereo camera is electrically connected to a device outside the stereo camera to execute an camera calibration process, wherein a processor of the device controls the left eye image capture unit and the right eye image capture unit to execute an image capture operation on the calibration pattern to generate at least one left eye image and at least one right eye image respectively, extracts a plurality of first feature points and a plurality of second feature points corresponding to the plurality of feature points to a memory of the device from the at least one left eye image and the at least one right eye image respectively, loads intrinsic parameters of the stereo camera to the memory, calculates camera calibration parameters corresponding to extrinsic parameters of the stereo camera according to the plurality of first feature points and the plurality of second feature points, and the intrinsic parameters, and executes the camera calibration process on the left eye image capture unit and the right eye image capture unit according to the camera calibration parameters, respectively.

26. The image calibration system of claim 25, wherein the calibration pattern is printed on a board, or the calibration pattern is stored in a storage device for being displayed on a display.

27. An image calibration system, comprising:
a stereo camera comprising a left eye image capture unit, a right eye image capture unit, and a processor; and
a calibration pattern;
wherein the processor utilizes a numerical optimization method and intrinsic parameters and extrinsic parameters of the stereo camera to execute an automatic calibration operation on the left eye image capture unit and the right eye image capture unit, calculates camera calibration parameters corresponding to the extrinsic parameters of the stereo camera after the processor executes the automatic calibration operation, executes an camera calibration process on the left eye image capture unit and the right eye image capture unit according to the camera calibration parameters corresponding to the extrinsic parameters of the stereo camera respectively, and utilizes a cost function to determine whether calibration of the left eye image capture unit and the right eye image capture unit meets a predetermined standard according to a difference between a calibrated left eye image and a calibrated right eye image generated by the left eye image capture unit and the right eye image capture unit executing an image capture operation on the calibration pattern respectively after the processor executes the camera calibration process.

28. The image calibration system of claim 27, wherein when the calibration of the left eye image capture unit and the right eye image capture unit fails to meet the predetermined standard, the processor utilizes the numerical optimization method and the intrinsic parameters and the extrinsic parameters of the stereo camera to execute the automatic calibration operation on the left eye image capture unit and the right eye image capture unit again.

29. The image calibration system of claim 27, wherein the intrinsic parameters and the extrinsic parameters of the stereo camera are stored in a memory, wherein the memory is further comprised in the stereo camera.

30. The image calibration system of claim 27, wherein the processor further loads the intrinsic parameters and the extrinsic parameters of the stereo camera to a memory, wherein the memory is further comprised in the stereo camera.

31. The image calibration system of claim 27, wherein the calibration pattern is printed on a board, or the calibration pattern is stored in a storage device for being displayed on a display.

32. An image calibration system, comprising:
a stereo camera comprising a left eye image capture unit and a right eye image capture unit; and
a calibration pattern;
wherein the stereo camera is electrically connected to a device outside the stereo camera to execute an camera calibration process, wherein a processor of the device loads intrinsic parameters and extrinsic parameters of the stereo camera, utilizes a numerical optimization method and the intrinsic parameters and the extrinsic parameters of the stereo camera to execute an automatic calibration operation on the left eye image capture unit and the right eye image capture unit, calculates camera calibration parameters corresponding to the extrinsic parameters of the stereo camera after the processor executes the automatic calibration operation, executes the camera calibration process on the left eye image capture unit and the right eye image capture unit according to the camera calibration parameters corresponding to the extrinsic parameters of the stereo camera respectively, and utilizes a cost function to determine whether calibration of the left eye image capture unit and the right eye image capture unit meets a predetermined standard according to a difference between a calibrated left eye image and a calibrated right eye image generated by the left eye image capture unit and the right eye image capture unit executing an image capture operation on the calibration pattern respectively after the processor executes the camera calibration process.

33. The image calibration system of claim 32, wherein the calibration pattern is printed on a board, or the calibration pattern is stored in a storage device for being displayed on a display.

34. An image calibration system, comprising:
a stereo camera comprising a left eye image capture unit, a right eye image capture unit, and a processor, wherein the processor is electrically connected to the left eye image capture unit and the right eye image capture unit, and the stereo camera has intrinsic parameters;
wherein the processor controls the left eye image capture unit and the right eye image capture unit to execute an image capture operation on a calibration pattern with a plurality of feature points to generate a plurality of first feature points and a plurality of second feature points corresponding to the plurality of feature points, calculates camera calibration parameters corresponding to the stereo camera according to the plurality of first feature points, the plurality of second feature points, and the intrinsic parameters, and executes an camera calibration process on the left eye image capture unit and the right eye image capture unit according to the camera calibration parameters.

35. The image calibration system of claim 34, wherein the camera calibration process makes the plurality of first feature points align to the plurality of second feature points in a row alignment way or a column alignment way.

36. The image calibration system of claim 34, wherein the calibration pattern with the plurality of feature points is a single frame pattern.

37. The image calibration system of claim 34, wherein the camera calibration parameters corresponding to the stereo camera is the camera calibration parameters corresponding to extrinsic parameters of the stereo camera.

38. The image calibration system of claim 34, wherein the camera calibration parameters corresponding to the stereo camera is the camera calibration parameters corresponding to extrinsic parameters and the intrinsic parameters of the stereo camera.
